(19) United States
(12) Patent Application Publication
(10) Pub. No.: US 2026/0186432 A1
(43) Pub. Date: Jul. 2, 2026

(54) FIXING DEVICE AND IMAGE FORMING APPARATUS

(71) Applicant: FUJIFILM Business Innovation Corp., Tokyo (JP)

(72) Inventors: Keita HASHIMOTO, Kanagawa (JP); Motoi NOYA, Kanagawa (JP); Jun SAWAMURA, Kanagawa (JP)

(73) Assignee: FUJIFILM Business Innovation Corp., Tokyo (JP)

(21) Appl. No.: 19/293,965

(22) Filed: Aug. 7, 2025

(30) Foreign Application Priority Data
Dec. 27, 2024 (JP) 2024-232973

(51) Int. Cl. G03G 15/20

(52) U.S. Cl. CPC G03G 15/2032; G03G 15/2064

(57) ABSTRACT

A fixing device includes: a heating member that heats an image formed on a recording medium; a pressing member that holds a recording medium between the heating member and the pressing member to press the recording medium against the heating member; a pusher that pushes the pressing member toward the heating member; an elastic member having a first end attached to the pusher, the elastic member being elastically deformable to impart the pressing member to a pressing force with which the pressing member presses a recording medium against the heating member; a swinging member to which a second end of the elastic member is attached, the swinging member being swingably supported on a support member, the swinging member determining elastic deformation of the elastic member in accordance with a position to which the swinging member is moved by swinging; and a positioning member that comes into contact with the swinging member to determine the position of the swinging member, the positioning member being supported on the support member.

### CROSS-REFERENCE TO RELATED APPLICATIONS

This application is based on and claims priority under 35 USC 119 from Japanese Patent Application No. 2024-232973 filed December 27, 2024.

### BACKGROUND

### (i) Technical Field

The present disclosure relates to a fixing device and an image forming apparatus.

### ii Related Art

A fixing device described in Japanese Unexamined Patent Application Publication No. 2009-139682 includes a heating roller and a pressure roller, which rotate while being in contact with each other, a rotatable pressure lever that presses the pressure roller against the heating roller, a pressure plate engaged with the pressure lever, an open-close lever that rotates in a manner interlocked with operations of opening and closing an open-close covering, and a pressure spring interposed between the open-close lever and the pressure plate. In the fixing device, the open-close lever is rotated in a manner interlocked with the operations of opening and closing the open-close covering to change the pressing force of the pressure spring, and thus the pressure roller is switched to a pressing state or a pressure release state. The fixing device includes a cam that selectively comes into contact with the pressure plate by rotating. The cam moves the pressure plate to reduce the pressing force of the pressure roller provided by the pressure spring.

### SUMMARY

A fixing device includes a heating member and a pressing member that presses a recording medium against the heating member. The fixing device includes an elastic member to impart the pressing member to a pressing force to press the recording medium. A first end of the elastic member is attached to a pusher that pushes the pressing member toward the heating member, and a second end of the elastic member is attached to a swinging member that is swingable. The fixing device also includes a positioning member that comes into contact with the swinging member and fixes the position of the swinging member.

In an existing technology, the positioning member and the swinging member are supported on different components. Thus, the swinging member that is swingable varies in position among devices due to, for example, the variation in assembly position during manufacture.

Aspects of non-limiting embodiments of the present disclosure relate to reduction of variation in position of a swinging member among devices compared with a structure where a positioning member and a swinging member are supported on different components.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device that includes:

a heating member that heats an image formed on a recording medium;

a pressing member that holds a recording medium between the heating member and the pressing member to press the recording medium against the heating member;

a pusher that pushes the pressing member toward the heating member;

an elastic member having a first end attached to the pusher, the elastic member being elastically deformable to impart the pressing member to a pressing force with which the pressing member presses a recording medium against the heating member;

a swinging member to which a second end of the elastic member is attached, the swinging member being swingably supported on a support member, the swinging member determining elastic deformation of the elastic member in accordance with a position to which the swinging member is moved by swinging; and

a positioning member that comes into contact with the swinging member to determine the position of the swinging member, the positioning member being supported on the support member.

### BRIEF DESCRIPTION OF THE DRAWINGS

Exemplary embodiments of the present disclosure will be described in detail based on the following figures, wherein:

FIG. 1 is a schematic structure diagram of an image forming apparatus according to an exemplary embodiment of the present disclosure;

FIG. 2 is a schematic structure diagram of a toner image forming portion included in an image forming apparatus according to an exemplary embodiment of the present disclosure;

FIG. 3 is a front view of a fixing device according to an exemplary embodiment of the present disclosure, in a state of being positioned at a first swing position;

FIG. 4 is a perspective view of a fixing device according to an exemplary embodiment of the present disclosure, in a state of being positioned at the first swing position;

FIG. 5 is a front view of a fixing device according to an exemplary embodiment of the present disclosure, in a state of being positioned at a second swing position; and

FIG. 6 is a perspective view of a fixing device according to an exemplary embodiment of the present disclosure, in a state of being positioned at the second swing position.

### DETAILED DESCRIPTION

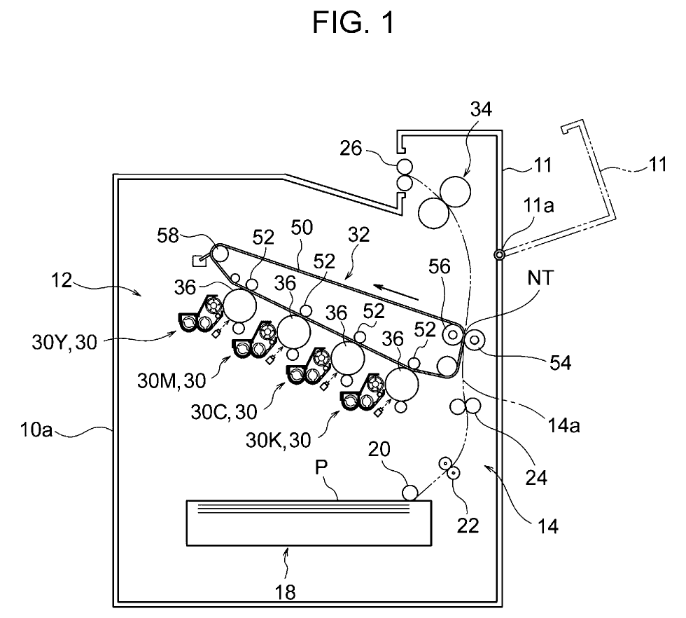

With reference to FIG. 1 to FIG. 6, examples of a fixing device and an image forming apparatus according to an exemplary embodiment of the present disclosure are described. Throughout the drawings, arrow H indicates a perpendicular direction, and a vertical direction of an image forming apparatus. Arrow W is orthogonal to arrow H and horizontal, and indicates a width direction of a system. Arrow D is orthogonal to arrow H and arrow W and horizontal, and indicates a depth direction of the image forming apparatus.

### Entire Structure of Image Forming Apparatus 10

As illustrated in FIG. 1, an image forming apparatus 10 includes an image forming portion 12 that forms toner images, and a transport portion 14 that transports sheet members P serving as recording media along a transport path 14a. The image forming apparatus 10 further includes a container member18 that accommodates the sheet members P.

In the image forming apparatus 10 with this structure, the transport portion 14 transports the sheet members P accommodated in a container member 18 along the transport path 14a. The image forming portion 12 forms toner images based on input image data. The toner images are then formed on the transported sheet members P, and the sheet members P on which the toner images are formed are discharged to the outside from a housing 10a.

### Image Forming Portion 12

As illustrated in FIG. 1, the image forming portion 12 includes multiple toner image forming portions 30 that form toner images of respective colors, and a transfer portion 32 that transfers the toner images formed by the toner image forming portions 30 to the sheet member P. The image forming portion 12 further includes a fixing device 34 that fixes a toner image transferred to the sheet member P by the transfer portion 32 onto the sheet member P.

### Toner Image Forming Portions 30

The toner image forming portions 30 are provided to form toner images of respective colors. In the present exemplary embodiment, the toner image forming portions 30 include toner image forming portions 30Y, 30M, 30C, and 30K for four colors including yellow (Y), magenta (M), cyan (C), and black (K). In the description below, Y, M, C, and K appended to the reference signs are omitted when the colors of yellow (Y), magenta (M), cyan (C), and black (K) are not to be distinguished from one another.

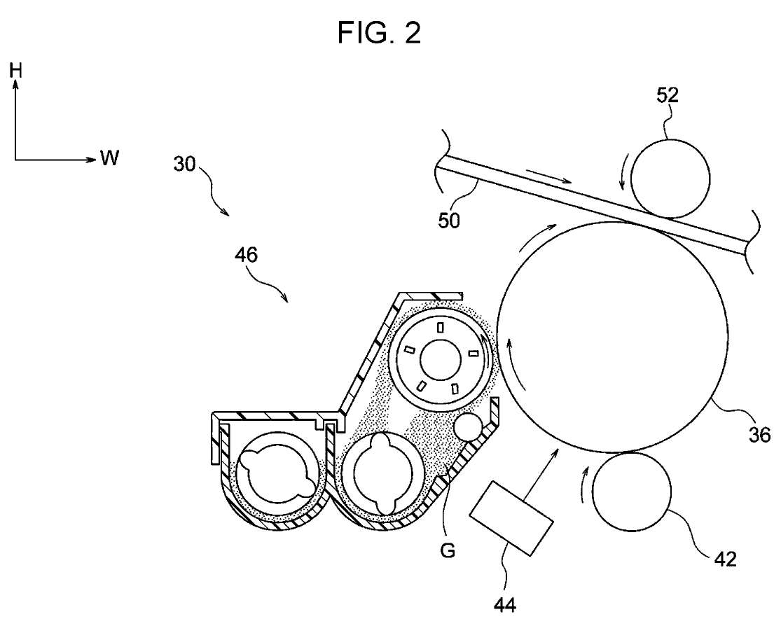

The toner image forming portions 30 for different colors have basically the same structure except for using different toner. As illustrated in FIG. 2, each toner image forming portion 30 includes a rotatable cylindrical image carrier 36 and a charging device 42 that charges the image carrier 36 with electricity. Each toner image forming portion 30 further includes an exposure device 44 that irradiates the charged image carrier 36 with exposure light to form electrostatic latent images, and a developing device 46 that develops the electrostatic latent images with a developer G containing toner into toner images. Thus, the toner image forming portions 30 for different colors form images of the different colors with toner of the different colors.

As illustrated in FIG. 1, the image carrier 36 for each color is in contact with a transfer belt 50 (described in detail below) that rotates. The toner image forming portions 30 for yellow (Y), magenta (M), cyan (C), and black (K) are arranged in this order from the upstream side in the rotation direction (indicated with an arrow in the drawing) of the transfer belt 50.

### Transfer Portion 32

As illustrated in FIG. 1, the transfer portion 32 includes the transfer belt 50, and first transfer rollers 52 each disposed opposite the image carrier 36 of the corresponding color with the transfer belt 50 interposed therebetween. The first transfer rollers 52 transfer toner images formed on the image carriers 36 of different colors to the transfer belt 50.

The transfer portion 32 includes a winding roller 56 around which the transfer belt 50 is wound, and a driving roller 58 around which the transfer belt 50 is wound and that transmits a rotational force to the transfer belt 50. Thus, the transfer belt 50 rotates in the arrow direction in the drawing.

The transfer portion 32 also includes a second transfer roller 54 disposed opposite the winding roller 56 with the transfer belt 50 interposed therebetween. The second transfer roller 54 transfers toner images transferred to the transfer belt 50 to the sheet members P. Between the second transfer roller 54 and the transfer belt 50, a transfer nip NT that transfers the toner images to the sheet members P is formed.

In this structure, in order of yellow (Y), magenta (M), cyan (C), and black (K), toner images are first-transferred to the transfer belt 50 by the first transfer rollers 52. In addition, the second transfer roller 54 transfers the toner images from the transfer belt 50 to the sheet members P transported while being held between the transfer belt 50 and the second transfer roller 54. In addition, the sheet members P to which the toner images are transferred are transported toward the fixing device 34.

### Fixing Device 34

As illustrated in FIG. 1, the fixing device 34 is disposed downstream from the transfer nip NT in the transport direction of the sheet members P. The fixing device 34 heats and presses the toner images transferred to the sheet members P to fix the toner images to the sheet members P. The fixing device 34 is described in detail later.

### Transport Portion 14

As illustrated in FIG. 1, the transport portion 14 includes a dispatch roller 20 that dispatches the sheet members P accommodated in the container member 18 to the transport path 14a, and stop rollers 22 that block transport of the sheet members P dispatched by the dispatch roller 20 in an overlapping manner. The transport portion 14 also includes adjustment rollers 24 that adjust the timing at which the sheet members P are dispatched to the transfer nip NT, and discharging rollers 26 that discharge the sheet members P to which the toner images are fixed by the fixing device 34 to the outside from the housing 10a.

### Others

As illustrated in FIG. 1, the housing 10a of the image forming apparatus 10 includes a maintenance door 11 that allows the fixing device 34 open to the outside. The maintenance door 11 rotates about a shaft 11a, and moves between a normal position (refer to a solid line) and an open position (refer to a two-dot chain line) in which the maintenance door 11 allows the fixing device 34 open to the outside.

### Structure of Related Portions

The fixing device 34 is then described in detail.

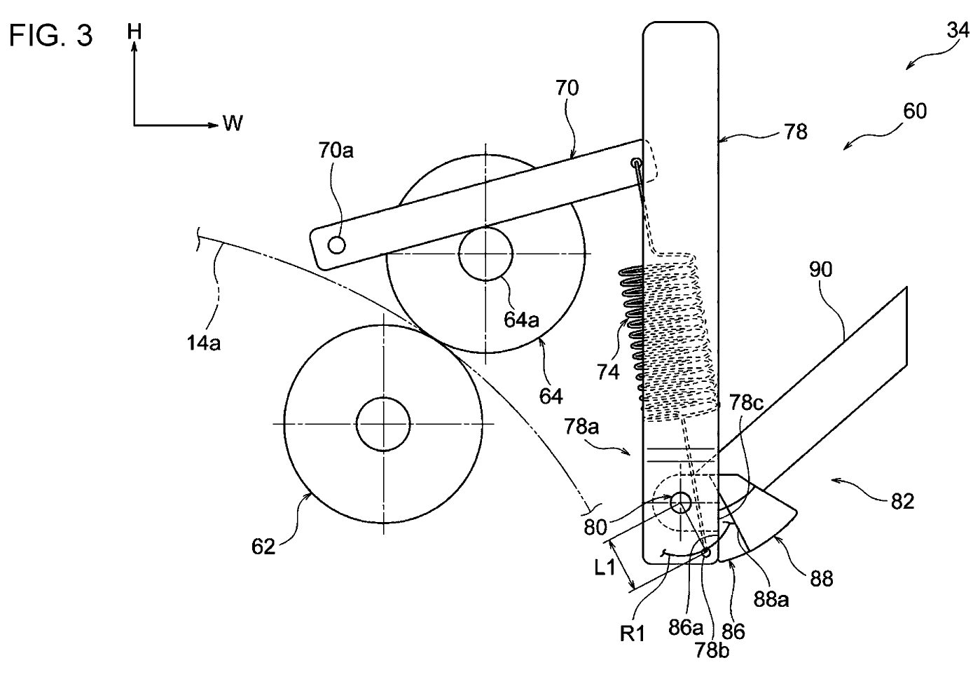

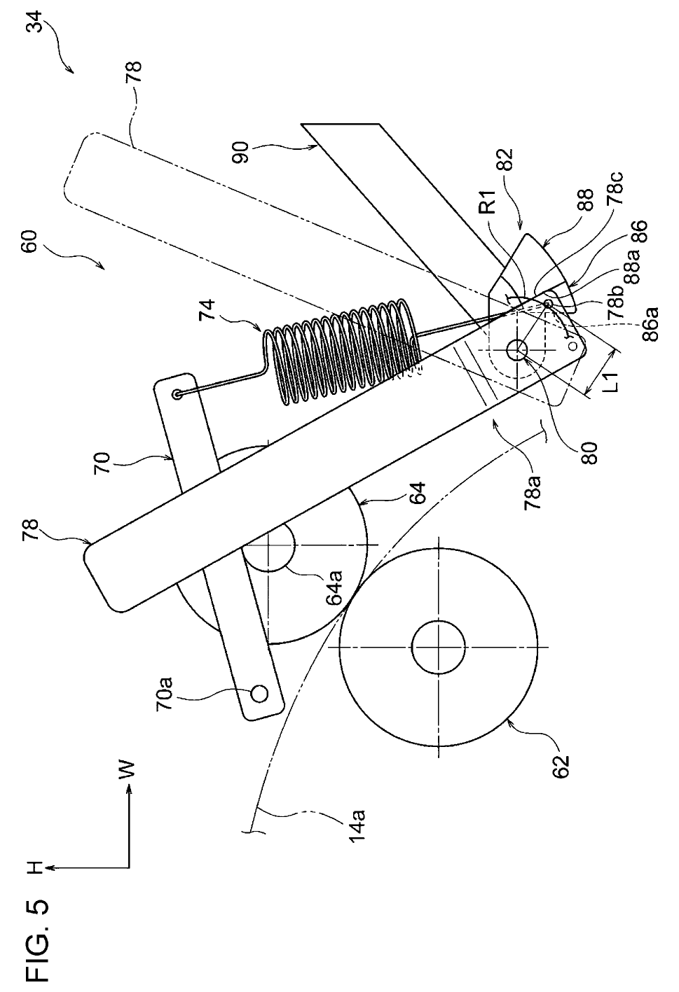

As illustrated in FIG. 3 and FIG. 5, the fixing device 34 includes a heating roller 62 that includes a heat source inside, and a pressing roller 64 that presses the sheet members P transported between the pressing roller 64 and the heating roller 62 against the heating roller 62. The pressing roller 64 is disposed above the heating roller 62. The pressing roller 64 is rotated by being driven by the heating roller 62 that rotates while receiving a driving force from a driving source not illustrated. The pressing roller 64 is an example of a pressing member. The heating roller 62 is an example of a heating member.

The fixing device 34 includes a pressing unit 60 that allows the pressing roller 64 to press the sheet members P against the heating roller 62. The pressing unit 60 includes a pair of pushers 70, a pair of extension springs 74, a pair of swinging members 78, and a pair of positioning members 82. The pair of pushers 70, the pair of extension springs 74, the pair of swinging members 78, and the pair of positioning members 82 are disposed while having the pressing roller 64 interposed therebetween in the depth direction. The pair of pushers 70, the pair of extension springs 74, the pair of swinging members 78, and the pair of positioning members 82 are symmetrical while having the pressing roller 64 interposed therebetween.

The swinging member 78 that swings is positioned by the positioning member 82 between a first swing position (refer to FIG. 3) and a second swing position (refer to FIG. 5). In a state where the swinging member 78 is positioned in the first swing position, the pressing force (the nip force) with which the pressing roller 64 presses the sheet member P against the heating roller 62 is a normal pressing force to hold a normal sheet. In contrast, in a state where the swinging member 78 is positioned in the second swing position, the pressing force (the nip force) with which the pressing roller 64 presses the sheet member P against the heating roller 62 is a low pressing force weaker than the normal pressing force. For example, when an envelope is used as the sheet member P, the pressing roller 64 presses the sheet member P against the heating roller 62 with the low pressing force to reduce creases caused in, for example, the envelope.

In the description below, the pusher 70, the extension spring 74, the swinging member 78, and the positioning member 82 located in front of the pressing roller 64 in the depth direction are described.

### Pusher 70

As illustrated in FIG. 3 and FIG. 5, the pusher 70 extends in a width direction to push, from above, a shaft 64a of the pressing roller 64 protruding in the depth direction. At a first end portion of the pusher 70 on one side in the width direction (on the left side in the drawing), a shaft 70a that swingably supports the pusher 70 extends in the depth direction. The shaft 70a is attached to a frame member, not illustrated.

A second end portion of the pusher 70 on the other side in the width direction (on the right side in the drawing) is disposed opposite to the first end portion of the shaft 70a with the shaft 64a of the pressing roller 64 interposed therebetween.

### Extension Spring 74

As illustrated in FIG. 3 and FIG. 5, the extension spring 74 is disposed to extend in the vertical direction. An upper end (a first end) of the extension spring 74 is attached to the second end portion of the pusher 70. The extension spring 74 is an example of an elastic member.

### Swinging Member 78

As illustrated in FIG. 3, when viewed in the depth direction, the swinging member 78 positioned in the first swing position is positioned opposite to the shaft 70a of the pusher 70 with the pressing roller 64 interposed therebetween. The swinging member 78 extends in the vertical direction. At a lower end portion of the swinging member 78 located at the bottom in the vertical direction, a cylindrical shaft member 80 that swingably supports the swinging member 78 extends in the depth direction. This shaft member 80 is attached to a frame member not illustrated. The shaft member 80 is an example of a support member.

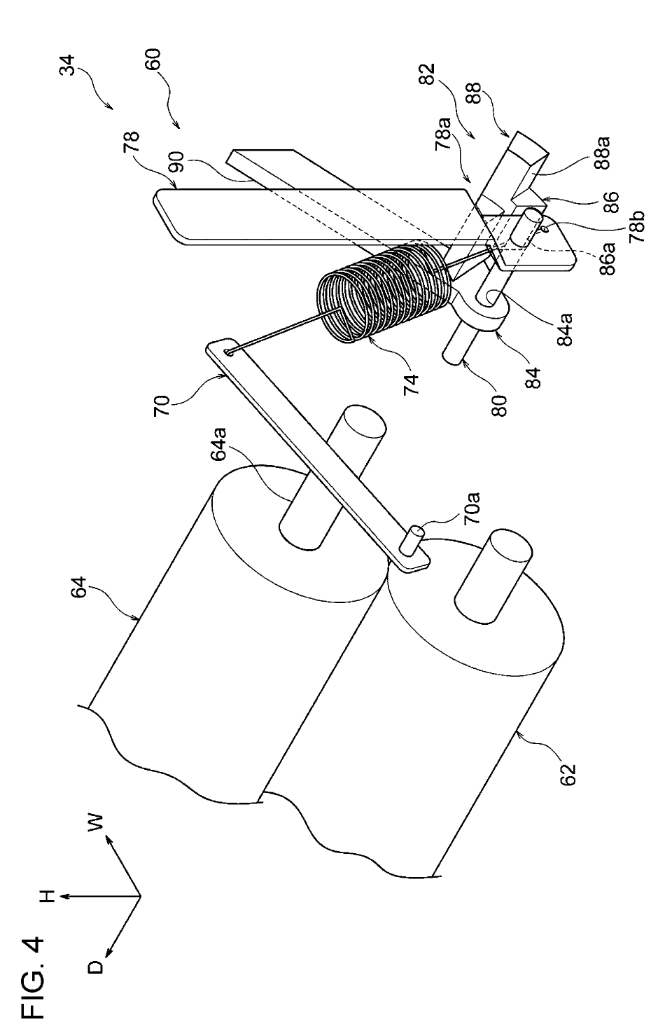

A portion of the swinging member 78 located above the shaft member 80 includes a bent portion 78a. The portion of the swinging member 78 located above the bent portion 78a is positioned further outward in the depth direction (positioned farther from the pressing roller 64) than a lower portion of the swinging member 78 (refer to FIG. 4).

As illustrated in FIG. 5, the swinging member 78 positioned in the second swing position is inclined with respect to the swinging member 78 positioned in the first swing position, or with respect to the vertical direction after swinging counterclockwise about the shaft member 80.

To the lower end portion of the swinging member 78, the lower end (the second end) of the extension spring 74 is attached. More specifically, the lower end of the extension spring 74 in the stretched state is attached to a mount portion 78b of the swinging member 78 at a portion of the swinging member 78 located below the shaft member 80.

In this structure, the tensile force (the elastic force) of the extension spring 74 exerts, on the swinging member 78, a rotational force to rotate the swinging member 78 counterclockwise about the shaft member 80. The tensile force caused by elastic deformation of the extension spring 74 causes the pressing force with which the pressing roller 64 presses the sheet member P against the heating roller 62 using the pusher 70.

More specifically, elastic deformation (elongation) of the extension spring 74 caused in the state where the swinging member 78 is positioned in the first swing position is greater than elastic deformation of the extension spring 74 caused in the state where the swinging member 78 is positioned in the second swing position. Thus, the pressing force of the pressing roller 64 exerted on the sheet member P in the state where the swinging member 78 is positioned in the first swing position is greater than the pressing force of the pressing roller 64 exerted on the sheet member P in the state where the swinging member 78 is positioned in the second swing position.

### Positioning Member 82

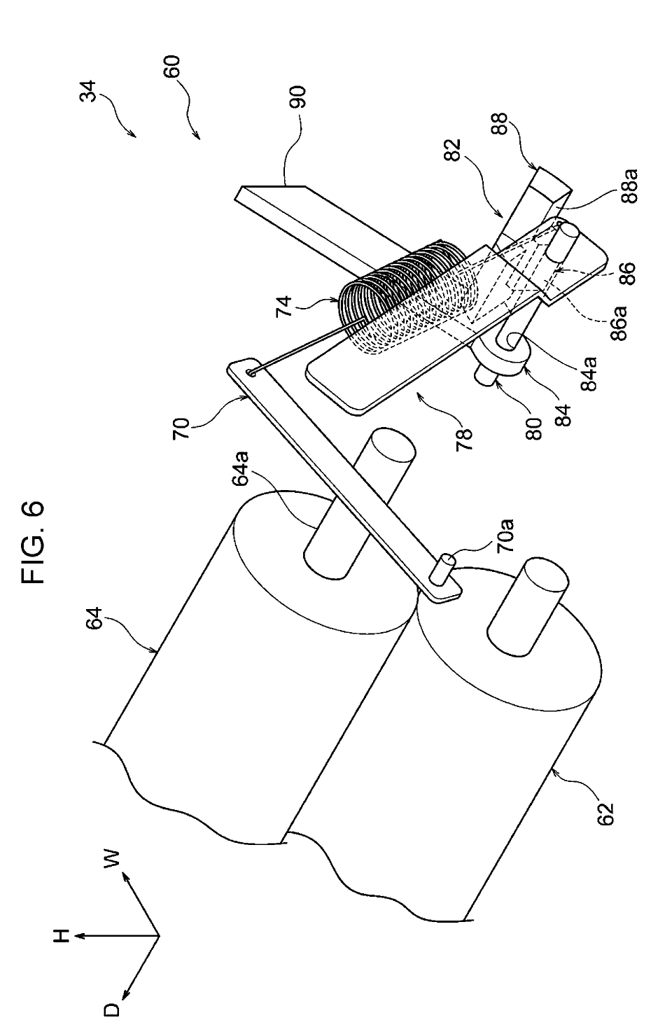

As illustrated in FIG. 4 and FIG. 6, the positioning member 82 is supported by the shaft member 80 that extends in the depth direction. More specifically, the positioning member 82 is supported in the same manner as the swinging member 78.

More specifically, the positioning member 82 includes an integrated unit including a support portion 84, a first positioning portion 86, a second positioning portion 88, and a grip 90, supported by the shaft member 80. The first positioning portion 86 is an example of a first positioning portion. The second positioning portion 88 is an example of a second positioning portion.

The support portion 84 is disposed at the back of the swinging member 78 (closer to the pressing roller 64) in the depth direction. The support portion 84 includes a circular through-hole 84a through which the shaft member 80 extends.

The first positioning portion 86 is disposed in front of the support portion 84 in the depth direction, and closer to a second end (the right in the drawing), in the width direction, of the lower end portion of the swinging member 78. The first positioning portion 86 includes a first contact portion 86a that comes into contact with the lower end portion of the swinging member 78 (refer to FIG. 3). A portion of the swinging member 78 that comes into contact with the first contact portion 86a is referred to as a to-be-touched portion 78c. The to-be-touched portion 78c and the mount portion 78b are positioned on the same side with respect to the shaft member 80.

As illustrated in FIG. 3, when viewed in the depth direction, a distance from the axis of the shaft member 80 to the mount portion 78b is defined as a distance L1. The to-be-touched portion 78c is positioned at a point on an arc R1 with a radius equal to the distance L1 and centered at the axis of the shaft member 80 while the first contact portion 86a is in contact with the lower end portion of the swinging member 78. The distance L1 is an example of a first distance.

As illustrated in FIG. 4, the second positioning portion 88 is disposed closer to the second end of the first positioning portion 86 in the width direction and in front of the first positioning portion 86 in the depth direction. In other words, the first positioning portion 86 and the second positioning portion 88 are arranged side by side in the depth direction, or an axial direction of the shaft member 80. The second positioning portion 88 includes a second contact portion 88a that comes into contact with the to-be-touched portion 78c of the swinging member 78 (refer to FIG. 5). The second contact portion 88a is an example of a contact portion.

As described above, the tensile force (the elastic force) of the extension spring 74 exerts, on the swinging member 78, the rotational force to rotate the swinging member 78 counterclockwise about the shaft member 80. In other words, the tensile force (the elastic force) of the extension spring 74 urges the swinging member 78 to bring the swinging member 78 into contact with the positioning member 82.

The grip 90 is disposed on the side opposite to the support portion 84 in the width direction, and extends in the width direction to the side away from the support portion 84 while using the support portion 84 as the base end.

In this structure, the positioning member 82 is movable in the depth direction along the shaft member 80 by an operator that grips the grip 90. The positioning member 82 moves between the first contact position (refer to FIG. 3 and FIG. 4) where the first contact portion 86a of the first positioning portion 86 comes into contact with the to-be-touched portion 78c of the swinging member 78, and the second contact position (refer to FIG. 5 and FIG. 6) where the second contact portion 88a of the second positioning portion 88 comes into contact with the to-be-touched portion 78c of the swinging member 78. When the first contact portion 86a comes into contact with the to-be-touched portion 78c of the swinging member 78, the swinging member 78 is positioned in the first swing position. When the second contact portion 88a comes into contact with the to-be-touched portion 78c of the swinging member 78, the swinging member 78 is positioned in the second swing position.

The second one of the positioning members 82 positioned opposite to the first one of the positioning members 82 with the pressing roller 64 interposed therebetween in the depth direction is coupled to the first one of the positioning members 82 with a mechanical component not illustrated to move in the same manner as the first one of the positioning members 82 when the first one of the positioning members 82 moves in the depth direction. In this manner, the pair of positioning members 82 move synchronously. With the synchronous movement of the pair of positioning members 82, the pair of swinging members 78 swing synchronously.

### Operations

Operations of related portions are described now.

As illustrated in FIG. 3 and FIG. 4, in the state where each positioning member 82 is positioned in the first contact position, the first contact portion 86a of the first positioning portion 86 comes into contact with the to-be-touched portion 78c of the corresponding swinging member 78. Thus, the swinging member 78 is positioned in the first swing position, and the pressing roller 64 presses the sheet member P against the heating roller 62 with a normal pressing force.

The operator moves the maintenance door 11 to the open position (refer to a two-dot chain line in FIG. 1). In addition, the operator grips the grip 90 of each positioning member 82 to move the corresponding positioning member 82 toward the far end in the depth direction along the shaft member 80. Thus, the positioning member 82 in the first contact position moves to the second contact position illustrated in FIG. 5 and FIG. 6. When each positioning member 82 moves to the second contact position, the second contact portion 88a of the second positioning portion 88 comes into contact with the to-be-touched portion 78c of the corresponding swinging member 78. Thus, the swinging member 78 is positioned in the second swing position, and the pressing roller 64 presses the sheet member P against the heating roller 62 with a low pressing force.

To move the swinging member 78 positioned in the second swing position to the first swing position, the operator moves the maintenance door 11 to the open position (refer to a two-dot chain line in FIG. 1). The operator grips an upper portion of each swinging member 78 illustrated in FIG. 5, and swings the swinging member 78. The operator then moves the swinging member 78 to a separate position (refer to a two-dot chain line in FIG. 5) where the to-be-touched portion 78c of the swinging member 78 is spaced apart from the second contact portion 88a of the second positioning portion 88, and fixes the swinging member 78 with a lock member not illustrated at the position. In this state, the operator grips the grip 90 of each positioning member 82, and moves the positioning member 82 toward the far end in the depth direction along the shaft member 80. Thus, the positioning member 82 in the second contact position moves to the first contact position as illustrated in FIG. 3 and FIG. 4.

When the locked swinging member 78 is unlocked, the swinging member 78 swings, and the to-be-touched portion 78c of the swinging member 78 comes into contact with the first contact portion 86a of the first positioning portion 86. Thus, the swinging member 78 is positioned in the first swing position, and the pressing roller 64 presses the sheet member P against the heating roller 62 with a normal pressing force.

### Summarization

As described above, in the fixing device 34, each positioning member 82 and the corresponding swinging member 78 are supported on the shaft member 80. In other words, each positioning member 82 and the corresponding swinging member 78 are supported on the same component. Thus, compared with a case where the positioning member and the swinging member are supported on respective members, this structure reduces variation in position of the swinging member 78 across the devices. In other words, this structure reduces variation, across the devices, in pressing force with which the pressing roller 64 presses the sheet member P against the heating roller 62.

Here, the same component is an integrated component that is not divisible unless being cut or undergoing another operation.

In the fixing device 34, each positioning member 82 and the corresponding swinging member 78 are supported on the cylindrical shaft member 80 extending in the depth direction. Thus, compared with the structure where the positioning member and the swinging member are attached to a plate-shaped frame at different positions, variation in position of the swinging member 78 across the devices is reduced.

In the fixing device 34, each positioning member 82 includes the first positioning portion 86 and the second positioning portion 88 that determine the position of the corresponding swinging member 78 while coming into contact with the swinging member 78. The swinging member 78 is thus allowed to be positioned at different positions. In other words, the swinging member 78 is allowed to be positioned at multiple positions. Thus, the pressing force with which the pressing roller 64 presses the sheet member P against the heating roller 62 may be varied into multiple values.

In the fixing device 34, the first positioning portion 86 and the second positioning portion 88 in each positioning member 82 are arranged side by side in the axial direction (the depth direction) of the shaft member 80. When each positioning member 82 is moved in the axial direction along the shaft member 80, the corresponding swinging member 78 comes into contact with the first contact portion 86a of the first positioning portion 86 or the second contact portion 88a of the second positioning portion 88. Thus, compared with a structure where the swinging member that is in contact with the first contact portion is brought into contact with the second contact portion as a result of attaching and removing the positioning member to and from the support member, the swinging member 78 that comes into contact with the first contact portion 86a comes into contact with the second contact portion 88a with a simpler mechanism.

In the fixing device 34, when viewed in the depth direction, the mount portion 78b of each swinging member 78 to which the lower end of the extension spring 74 is attached, and the to-be-touched portion 78c of the swinging member 78 with which the first contact portion 86a and the second contact portion 88a come into contact are positioned on the same side with respect to the shaft member 80. Thus, compared with a structure where the mount portion that receives the extension spring and the to-be-touched portion are positioned opposite to each other with respect to a shaft member, this structure improves flexibility in shape of the swinging member 78 on the side of the swinging member 78 opposite to the mount portion 78b that receives the extension spring 74 and the to-be-touched portion 78c with respect to the shaft member 80.

In the fixing device 34, when viewed in the depth direction, and when the distance from the axis of the shaft member 80 to the mount portion 78b is defined as a distance L1, the to-be-touched portion 78c is positioned at a point on an arc R1 with a radius equal to the distance L1 and centered at the axis of the shaft member 80. Thus, compared with a structure where the arc R1 and the to-be-touched portion are spaced apart from each other, this structure further reduces deformation of the swinging member 78, and thus reduces variation in position of the swinging member 78 among the devices.

The image forming apparatus 10 includes the fixing device 34. Thus, compared with a structure including a fixing device where a swinging member and a positioning member are supported on different components, this structure further reduces variation in quality of fixing toner images to the sheet member P among the devices.

The present disclosure is described in detail based on a specific exemplary embodiment. However, it is apparent to those skilled in the art that the present disclosure is not limited to the exemplary embodiment, and may employ various other exemplary embodiments within the scope of the present disclosure. For example, in the exemplary embodiment, two positioning portions including the first positioning portion 86 and the second positioning portion 88 come into contact with the swinging member 78, but three or more positioning portions or one positioning portion may come into contact with the swinging member 78. However, the structure including one positioning portion has no effect caused by the structure including two positioning portions.

In the above exemplary embodiment, the pressing roller 64 with a roller shape is used as a pressing member, but the pressing member may be a component including a pressing belt.

In the above exemplary embodiment, each positioning member 82 and the corresponding swinging member 78 are supported on the shaft member 80, but may be supported on a plate-shaped frame member at different positions. However, the structure has no effect caused by each positioning member 82 and the corresponding swinging member 78 being supported on the shaft member.

In the above exemplary embodiment, the operator swings each swinging member 78 to a position indicated with a two-dot chain line illustrated in FIG. 5, but a mechanism to swing the swinging member in a manner interlocked with the operations of opening and closing the maintenance door 11 may be provided.

Although the fixing device according to the above exemplary embodiment includes the two positioning members 82, the fixing device may include one positioning member or multiple positioning members to change the pressing force with which the sheet member P is pressed against the heating roller 62.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A fixing device comprising:

a heating member that heats an image formed on a recording medium;

a pressing member that holds a recording medium between the heating member and the pressing member to press the recording medium against the heating member;

a pusher that pushes the pressing member toward the heating member;

an elastic member having a first end attached to the pusher, the elastic member being elastically deformable to impart the pressing member to a pressing force with which the pressing member presses a recording medium against the heating member;

a swinging member to which a second end of the elastic member is attached, the swinging member being swingably supported on a support member, the swinging member determining elastic deformation of the elastic member in accordance with a position to which the swinging member is moved by swinging; and

a positioning member that comes into contact with the swinging member to determine the position of the swinging member, the positioning member being supported on the support member.

(((2))) The fixing device according to (((1))),

wherein the support member is a cylindrical shaft member that swingably supports the swinging member and that extends in an axial direction of the swinging member, and

wherein the positioning member is attached to and supported on the shaft member.

(((3))) The fixing device according to (((1))) or (((2))),

wherein the positioning member includes a plurality of positioning portions that come into contact with the swinging member to determine the position of the swinging member, and the swinging member positioned at a plurality of postions.

(((4))) The fixing device according to (((3))),

wherein the support member is a cylindrical shaft member that swingably supports the swinging member and that extends in an axial direction of the swinging member,

wherein the plurality of positioning portions are arranged side by side at different positions in the axial direction, and

wherein, when the swinging member that is in contact with a first one of the positioning portions moves the positioning member in the axial direction along the shaft member, the swinging member comes into contact with a second one of the positioning portions while being spaced apart from the first one of the positioning portions.

(((5))) The fixing device according to any one of (((1))) to (((4))),

wherein the support member is a cylindrical shaft member that swingably supports the swinging member and that extends in an axial direction of the swinging member, and

wherein, when viewed in the axial direction, a mount portion in the swinging member to which a second end of the elastic member is attached and a to-be-touched portion in the swinging member with which the positioning member comes into contact are located on the same side with respect to the shaft member.

(((6))) The fixing device according to (((5))),

wherein the swinging member is urged with an elastic force of the elastic member to come into contact with the positioning member, and

wherein, when viewed in the axial direction, and when a distance from an axis of the shaft member to the mount portion is defined as a first distance, the to-be-touched portion is positioned at a point on an arc with a radius equal to the first distance and centered at the axis of the shaft member.

(((7))) An image forming apparatus, comprising:

a forming portion that forms an image on a recording medium; and

the fixing device according to any one of (((1))) to (((6))) that fixes an image formed on a recording medium by the forming portion to the recording medium.

What is claimed is:

1. A fixing device comprising:
a heating member that heats an image formed on a recording medium;
a pressing member that holds a recording medium between the heating member and the pressing member to press the recording medium against the heating member;
a pusher that pushes the pressing member toward the heating member;
an elastic member having a first end attached to the pusher, the elastic member being elastically deformable to impart the pressing member to a pressing force with which the pressing member presses a recording medium against the heating member;
a swinging member to which a second end of the elastic member is attached, the swinging member being swingably supported on a support member, the swinging member determining elastic deformation of the elastic member in accordance with a position to which the swinging member is moved by swinging; and
a positioning member that comes into contact with the swinging member to determine the position of the swinging member, the positioning member being supported on the support member.

2. The fixing device according to claim 1,
wherein the support member is a cylindrical shaft member that swingably supports the swinging member and that extends in an axial direction of the swinging member, and
wherein the positioning member is attached to and supported on the shaft member.

3. The fixing device according to claim 1,
wherein the positioning member includes a plurality of positioning portions that come into contact with the swinging member to determine the position of the swinging member, and the swinging member is positioned at a plurality of positions.

4. The fixing device according to claim 3,
wherein the support member is a cylindrical shaft member that swingably supports the swinging member and that extends in an axial direction of the swinging member,
wherein the plurality of positioning portions are arranged side by side at different positions in the axial direction, and
wherein, when the swinging member that is in contact with a first one of the positioning portions moves the positioning member in the axial direction along the shaft member, the swinging member comes into contact with a second one of the positioning portions while being spaced apart from the first one of the positioning portions.

5. The fixing device according to claim 1,
wherein the support member is a cylindrical shaft member that swingably supports the swinging member and that extends in an axial direction of the swinging member, and
wherein, when viewed in the axial direction, a mount portion in the swinging member to which a second end of the elastic member is attached and a to-be-touched portion in the swinging member with which the positioning member comes into contact are located on the same side with respect to the shaft member.

6. The fixing device according to claim 5,
wherein the swinging member is urged with an elastic force of the elastic member to come into contact with the positioning member, and
wherein, when viewed in the axial direction, and when a distance from an axis of the shaft member to the mount portion is defined as a first distance, the to-be-touched portion is positioned at a point on an arc with a radius equal to the first distance and centered at the axis of the shaft member.

7. An image forming apparatus, comprising:
a forming portion that forms an image on a recording medium; and
the fixing device according to claim 1 that fixes an image formed on a recording medium by the forming portion to the recording medium.

8. An image forming apparatus, comprising:
a forming portion that forms an image on a recording medium; and
the fixing device according to claim 2 that fixes an image formed on a recording medium by the forming portion to the recording medium.

9. An image forming apparatus, comprising:
a forming portion that forms an image on a recording medium; and
the fixing device according to claim 3 that fixes an image formed on a recording medium by the forming portion to the recording medium.

10. An image forming apparatus, comprising:
a forming portion that forms an image on a recording medium; and
the fixing device according to claim 4 that fixes an image formed on a recording medium by the forming portion to the recording medium.

11. An image forming apparatus, comprising:
a forming portion that forms an image on a recording medium; and
the fixing device according to claim 5 that fixes an image formed on a recording medium by the forming portion to the recording medium.

12. An image forming apparatus, comprising:
a forming portion that forms an image on a recording medium; and
the fixing device according to claim 6 that fixes an image formed on a recording medium by the forming portion to the recording medium.

13. A fixing device comprising:
heating means for heating an image formed on a recording medium;
pressing means for holding a recording medium between the heating means and the pressing means to press the recording medium against the heating means;
pushing means for pushing the pressing means toward the heating means;
elastic means having a first end attached to the pushing means, the elastic means being elastically deformable to impart the pressing means to a pressing force with which the pressing means presses a recording medium against the heating means;
swinging means to which a second end of the elastic means is attached, the swinging means being swingably supported on support means, the swinging means determining elastic deformation of the elastic means in accordance with a position to which the swinging means is moved by swinging; and
positioning means for coming into contact with the swinging means to determine the position of the swinging means, the positioning means being supported on the support means.
